(19) United States
(12) Patent Application Publication
(10) Pub. No.: US 2004/0204187 A1
(43) Pub. Date: Oct. 14, 2004

(54) Support structure for mobile phone with integrated antenna

(76) Inventor: Peter Nevermann, San Diego, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 10/113,992

(22) Filed: Apr. 1, 2002

(51) Int. Cl. H04B 1/38

(52) U.S. Cl. 455/575.1; 455/345; 455/90.3

(57) ABSTRACT

According to a specific embodiment, a support structure for a mobile phone is disclosed having a first section extending substantially vertically having a section for receiving and supporting the mobile phone. The first section has a coupler for electrical connection with the mobile phone. The support structure also has a second section coupled with the first section extending substantially horizontally having a distal end section including an antenna being electrically coupled with the coupler in the first section. The antenna is coupled with the coupler using a cable, which in some preferred embodiments is within a coupling section between the first and second sections.

### BACKGROUND OF THE INVENTION

The present invention relates generally to mobile phones and in particular to support structures for mobile phones for the use within a vehicle.

The use of mobile phones in automobiles is becoming increasingly popular, and for many people it has become a necessity to use their phones while they are travelling in their cars. In their cars, many people use their mobile phones without any support structure (such as a hands free kit).

Conducting a phone call while handling an automobile can jeopardize the safety of the automobile driver, passengers and others. To try to deal with this safety issue, legislatures of more and more states all over the world are trying to ban or restrict the use of mobile phones without a hands free kit during driving. Due to enacted or potential legislation in this area, in some states/countries a driver may not be able to operate legally a vehicle when using his phone while driving. Also, in some countries such as the United States there may be rules (e.g., the Federal Communication Commission (FCC) rules) outlining the requirements regarding maximum radiated power coming from mobile phones. Therefore, multiple hands free kits are readily available for mobile phones.

Another issue with using a mobile phone within a vehicle is potential interference of electromagnetic waves generated by the antenna with electronic car equipment. Furthermore, due to the shielding effect of the car chassis, mobile phones operate often at their maximum transmission power to be able to counter the damping effects of car chassis and to provide proper wireless connections with a base station. Many people are growing increasingly concerned about exposure to high radiation levels generated in close proximity to the head when mobile phones are used without a hands free car kit. This concern may exist even when the phone is used with a hands free car kit due to the higher transmission power levels that may exist when operating the mobile phone within a car chassis. Even though such hands free kit accessories are available from mobile phone manufactures as original accessories or from third party providers, most of these accessories either do not support an external antenna or involve a cumbersome installation procedure. Using a mobile phone within a car works reasonably well in practice as long as the phone is placed close to the window. This is due to the fact that the phone uses its own optimized antenna. However, the phone normally is placed in a non-optimal position when the user holds the phone in one of his hands (sometimes switching back and forth between hands). Even if the user has a hands free car kit for the mobile phone, the user/installer of the hands free car kit may not be aware of the shielding capability of the metal of the car chassis. Thus, the phone and hands free car kit are placed oftentimes towards the middle of the dashboard by the lower middle console where the car's power outlet usually is located.

Furthermore, automobile manufactures may exclude certain warranties because they are concerned about possible interaction of the mobile phone antenna's radiation with the automobile's electronics. In the past during the initial introduction of air bag systems and anti-lock brake systems (AB S) in automobiles, some electromagnetic interference occurred when the automobile came close, for example, to radio stations and TV stations. Although these interference problems have been resolved years ago and today's cars don't seem to experience interference problems with mobile phones, the above concerns still exist.

FIGS. 1a and 1b show hands free car kits installed in a vehicle according to the prior art. In FIG. 1a, the car 400 includes a hands free car kit 405 which supports a mobile phone. The mobile phone has a built-in antenna, and the car kit 405 typically is placed towards the middle of the dashboard by the lower middle console where the car's power outlet usually is located. As seen by the arrows in FIG. 1a, the radiation from the mobile phone's built-in antenna radiates outwardly in all directions (generally, an isotropic antenna) when the mobile phone is held in the hands free kit 405. In FIG. 1b, the car 400 includes a hands free car kit 410 which supports a mobile phone and attaches to an external antenna 420. A driver can place his mobile phone in this support structure 410. The support structure 410 has connections for power supply and external antenna 420. A radio frequency cable 430 couples the support structure 410 with external antenna 420 that is placed somewhere on top of the outside roof of the car chassis. However, installation of such an antenna requires making a hole somewhere in the car for the cable attachment to the external antenna and/or some other mechanical impact to the car. Furthermore, to connect the hands free car kit 410 to external antenna 420 for example at the car roof, approximately three meters or more of radio frequency cable are needed. Usually the cable quality of affordable cable is rather poor at high frequencies, for example, for the 1900 MHz band used in the United States. A damping factor of 5 dB/m or more associated with the use of the cable applies. Therefore, even in a case of a high gain antenna with 9 dBi power output used with a three meter cable, the overall power budget is extremely bad (9 dB−15 dB=−6 dB). In other words, only 25% of the radiated power is used for the given example. With the possible use of even higher frequencies in upcoming generations of mobile phones, these problems can become even worse as cable attenuation increases with frequency.

Therefore, there is a need of an improved support structure for mobile phones for the use within motor vehicles that does not require any alterations to the vehicle and still provides good performance for the hands free car kit system.

### SUMMARY OF THE INVENTION

The present invention, according to various embodiments, advantageously provides an improved support structure for mobile phones for use in vehicles.

According to a specific embodiment, the present invention provides a support structure for a mobile phone for use in a vehicle. The support structure includes a first section extending substantially vertically having a portion for receiving and supporting the mobile phone. The first section includes a coupler for electrical connection with the mobile phone. The support structure also includes a second section coupled with the first section and extending substantially horizontally including a distal end section including an antenna being electrically coupled with the connector.

According to another specific embodiment, the present invention provides a support structure for a mobile phone used in a vehicle. The support structure includes a first section for receiving and supporting the mobile phone, and includes a coupler for electrical connection with the mobile phone. The support structure also includes a second section including an antenna being electrically coupled via a RF transmission line with the connector. The second section is shaped to be placed on top of a dashboard of the vehicle close to the vehicle's front windshield.

A more complete understanding of these and various other specific embodiments and advantages thereof may be acquired by referring to the following description taken in conjunction with the accompanying drawings, in which like reference numbers indicate like features.

### BRIEF DESCRIPTION OF THE DRAWINGS

FIG. 1a shows a hands free car kit according to the prior art;

FIG. 1b shows another hands free car kit according to the prior art;

FIG. 2 shows a sectional side view of a first embodiment of the present invention;

FIG. 3 shows a sectional side view of a second embodiment of the present invention;

FIG. 4 shows a schematic diagram of the placement of one of the embodiments within a motor vehicle; and

FIG. 5 shows a partial sectional side view of yet another embodiment of the present invention.

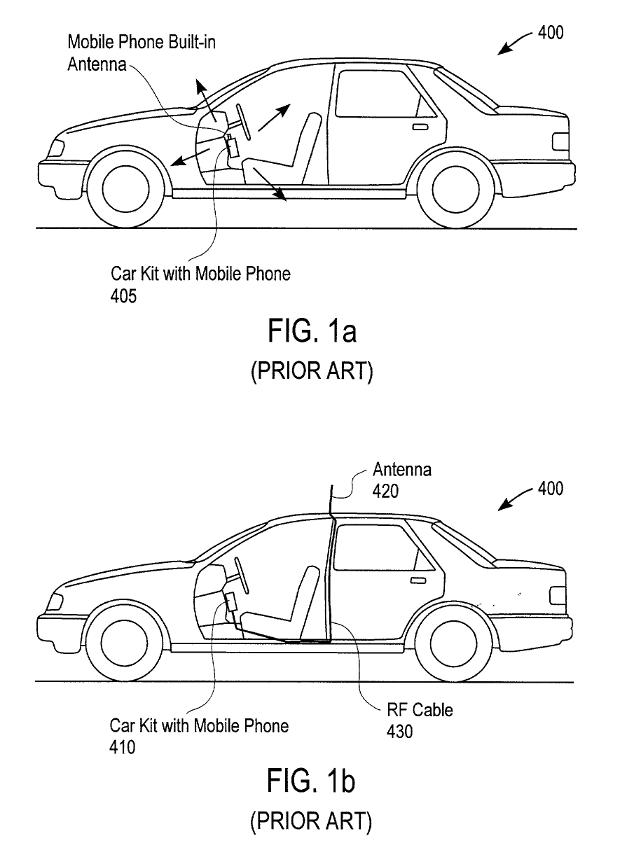

### DETAILED DESCRIPTION OF THE SPECIFIC EMBODIMENTS

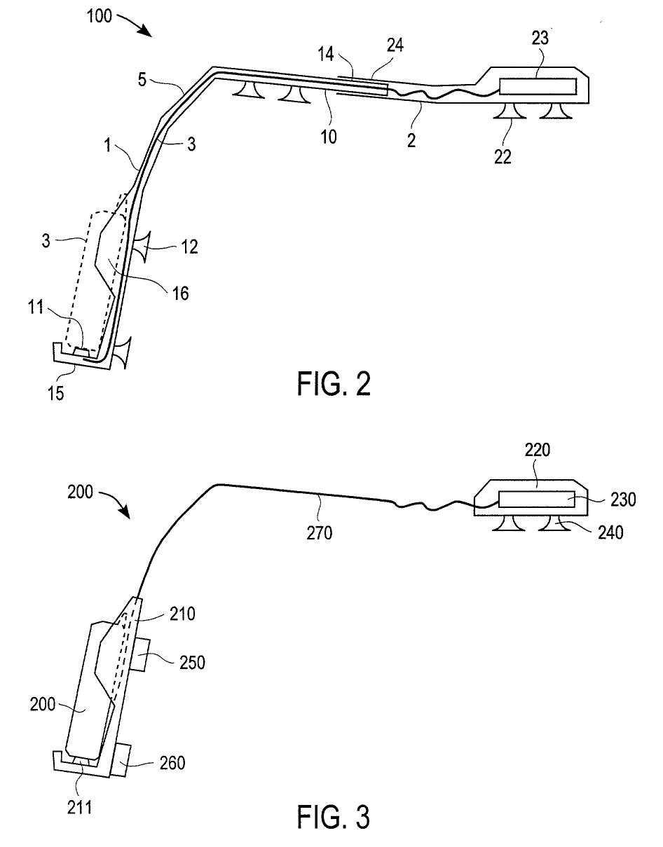

FIG. 2 shows a sectional side view of a support structure 100 according to a first embodiment of the present invention. Support structure 100 includes a first section 1 that extends substantially vertically and includes portions 15 and 16 adapted to receive and support a mobile phone 3 (shown in dotted line). Bottom plate 15 includes a coupler 11 for providing an external voltage supply and coupling to an external antenna. For example, coupler 11 may be a connector and/or an electromagnetic coupler, and coupler 11 provides at least one electrical connection or coupling between the phone and the support structure (in some embodiments, the coupler 11 may include a connector for certain electrical connections as well as include an electromagnetic coupler for RF connection). Furthermore, coupler 11 can connect to a hands free system, for example, incorporated into a stereo system within a car or to a separate hands free system having a speaker and a microphone for a suitable speakerphone system. Coupler 11 can be placed on different parts of support structure 100 depending on the design of the respective mobile phone 3. For example, if the mobile phone includes a connector on its backside, a respective mating connector would be placed on the respective position of the back plane of first section 1 of the support structure 100. (Similarly, if the mobile phone includes an electromagnetic coupler, another respective “mating” electromagnetic coupler would be placed on support structure 100.) Side elements 16 extend from the supporting back plane to provide stable lateral support for the mobile phone 3 when placed into the support structure 100.

A second section 10 of the support structure 100 extends substantially horizontally and includes at its distal end an end section 14 which mates with or receives and supports an extendable section 2. Although end section 14 is shown in FIG. 2 as being inserted into extendable section 2, the extendable section 2 could be inserted into end section 14 in various embodiments of the invention as described in this disclosure. Horizontal and vertical portions 1 and 10 are connected by a connecting section 5 of support structure 100. Connecting section 5 can be an about 90 degree coupling element, can have the form of a circular sector, or can be arranged in an angular configuration, as shown, to connect the horizontal and vertical sections 1 and 10 of support structure 100.

The support structure 100 also includes mechanical elements 12 to fix the support structure 100 to the car, e.g., to the dashboard. Mechanical elements 12 can be, for example, suction cups (as shown), velcro strap elements, adhesive tabs, or the like which attach to respective counter elements on the dashboard or any other suitable fixture. These mechanical elements 12 can be placed at the horizontal portion 10 and the vertical portion 1.

Support structure 100 can also include a hollow passage approximately from connector 11 to the outlet of end section 14. The hollow passage receives and supports a radio frequency cable, for example a coaxial cable 13, or any other waveguide or other transmission line. End structure 14 has an outlet for radio frequency cable 13. The extendable section 2 has an end portion 24 which can fit or slide (adjustably in some embodiments) over a mating end portion 14 of horizontal portion 10. The distal end of extendable section 2 includes a housing which contains an antenna 23. It is understood that in some embodiments, the horizontal portion 10 can be integrally formed with the antenna portion 2 and the coupling section 5 such that an upper part of vertical portion 1 has an end (similar to end 14 discussed above) and the integral horizontal/coupling/antenna piece has a mating end (similar to end 24 discussed above). Also, in other embodiments, the horizontal portion 10 can be integrally formed with the antenna portion 2 such that an upper part of the coupling section 5 has an end (similar to end 14 discussed above) and the integral horizontal/antenna piece has a mating end (similar to end 24 discussed above). In still further embodiments, the horizontal portion 10 can be integrally formed with the antenna portion 2 and an upper part of coupling portion 5, and the vertical portion 10 can be integrally formed with a lower part of coupling portion 5, such that the upper part of the integral vertical/lower coupling piece has an end (similar to end 14 discussed above) and the integral horizontal/upper coupling/antenna piece has a mating end (similar to end 24 discussed above). According to these various embodiments, the mating can be fixed and/or adjusted to fit onto a particular dashboard.

According to the present invention, antenna 23 is designed to generate a specific transmission pattern as will be explained in more detail below. The antenna 23 is coupled with coupler 11 (e.g., connector and/or electromagnetic coupler) through radio frequency cable 13. Radio frequency cable 13 is long enough to support a maximum extension of the extendable section 2. The middle section of extendable portion 2 contains enough hollow space to provide room for the cable when the extendable portion is at its minimum distance from the horizontal portion 10. For a secure placement of this antenna section 2, at least one mechanical element 22 also can be provided to fix the adjustable antenna portion of support structure 100 to the dashboard of a car. Mechanical element 22 may be, for example, suction cups, velcro straps, adhesive tabs, or any other suitable fixture.

The support structure 100 according to the present invention can be attached to any kind or size of dashboard by means of its adjustable antenna section 2. It can be placed on the left or right side of the steering wheel of any type of car 300 as shown in FIG. 3. When the support structure 100 is placed on the dashboard of a car 300, the horizontal portion 10 and the vertical portion 1 are first attached to the dashboard, for example, by means of the suction elements 12. Then the adjustable antenna portion is extended to its respective maximum length allowed by the design of the respective dashboard to place the antenna 23 as close as possible to the front windshield of car 300.

In another embodiment, the antenna portion 2 can be fixed in its horizontal portion with respect to end 14. This embodiment comprises only a single horizontal section ending in a housing for the antenna (rather than having any extendable portion as described above for various embodiments). In this case different versions of the support structure for different dashboards can be provided.

FIG. 3 shows a structure 200 according to yet another embodiment of the invention. In this embodiment, structure 200 includes two separate support structures 210 and 220. Element 210 receives the mobile phone 200 and includes a coupler 211 (similarly as described for coupler 11 in connection with FIG. 2). This support structure 210 can be similar in shape to the vertical portion 1 shown in FIG. 2 but truncated. Mechanical elements 250 and 260 (similar to mechanical elements 12 described in connection with FIG. 2) are provided to attach the mobile phone support structure 210 to a dashboard or perhaps to the driver side door interior. Antenna support structure 220 is essentially a housing for an antenna element 230 and also has mechanical elements 240 (similar to mechanical elements 22 described in connection with FIG. 2) to attach the antenna structure 220 to the upper portion of a dashboard near the window. In preferred embodiments, the housing has directions printed thereon indicating where the housing should be placed (e.g., on the dashboard or driver side door interior) to avoid interference with vehicle electronics. Antenna element 230 within housing 220 is coupled with a mobile phone 200 through a radio frequency cable 270 coupled to coupler 211.

This embodiment of FIG. 3 is attached to the dashboard in a similar way as the integrated embodiment shown in FIG. 2. Element 210 can be fixed to the vertical portion of the dashboard whereas the antenna housing 220 can be placed or fixed on top of the dashboard as close as possible to the window. This solution is particular convenient for dashboards that do not allow fixture of the support structure as shown in FIG. 2 due to the mechanical design.

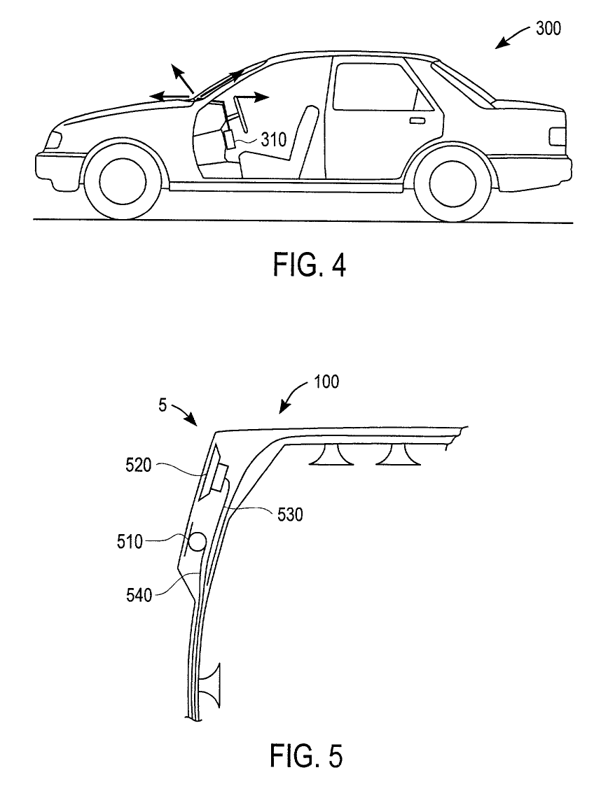

FIG. 4 shows the specific transmission pattern generated by the antenna in the support structure 310 used in vehicle 300 according to various embodiments of the present invention. In particular, antenna 23 of support structure 100 or antenna 230 of support structure 200 preferably is a non-isotropic or directional antenna, for example, a mobile phone antenna of the planar inverted F antenna (PIFA) type or a patch type antenna. Antenna 23/230 can be supportive of one or multiple bands. Especially integrated mobile phone antennas with an enhanced ground plane can be used as the non-isotropic antennas. These antennas will support exactly the same band as the mobile phone itself. This may be realized, e.g., by an enlarged ground plane. The structure of the antenna allows a transmission distribution (see arrows showing non-isotropic, upward radiation from the antenna) according to FIG. 4 which directs any transmission preferably in directions where a base station can be expected. As seen by these arrows, transmission downwards (e.g., in directions toward vehicle electronics) can be avoided with the use of such antennas. The antenna's radiated energy is thus sent in useful directions (toward some base station based on the unpredictable position of the mobile phone/car kit/vehicle) and at the same time unnecessary interference with car electronics as well as the driver can be avoided.

FIG. 5 shows yet another embodiment of the support structure shown in FIG. 2. For simplicity, only the coupling section 5 of FIG. 2 as modified according to this embodiment is shown in FIG. 5. This coupling section 5 is provided with an expanded volume to be able to include therein an audio input/output system. Since this coupling section of the support structure has its front side directed into the inside of the car, it can be expanded to include a compartment containing a microphone 510 and a speaker 520 for providing the audio system. Both microphone 510 and a speaker 520 face the front plate of the support structure section 5. Moreover, additional speakerphone circuitry (not shown in FIG. 5) emulating a speakerphone function can also be included in this compartment. If the mobile phone already includes a built-in speakerphone function, only the electrical connections 530 and 540 are needed to connect the loudspeaker 520 and microphone 510 to the coupler 11. Thus, a compact system with minimally visible external cable can be provided.

In yet another embodiment, this compartment within support structure section 5 only has a microphone 510. Instead of an integrated loudspeaker, a respective connection to the vehicle's stereo system can be provided. Thus, the loudspeaker already present in the car can be used for sound reproduction of the attached mobile phone.

The above embodiments can be provided with a power cord from the support structure such that the mobile phone also can be powered up by the vehicle's power system.

What is claimed is:

1. A support structure for a mobile phone for use in a vehicle comprising:
a first section extending substantially vertically having a portion for receiving and supporting the mobile phone including a coupler for electrical connection with the mobile phone;
a second section coupled with said first section and extending substantially horizontally including a distal end section including an antenna being electrically coupled with the connector.

2. The support structure of claim 1, wherein said second section comprises a first extension end and a movable extension section including the distal end, wherein the movable extension section mates with the first extension end.

3. The support structure of claim 2, wherein said movable extension section is mated with said first extension end such that the length of the second section can be adjusted in length.

4. The support structure of claim 1 wherein said antenna and said coupler are electrically coupled with a RF transmission line disposed in a coupling section coupled to said first section and to said second section.

5. The support structure of claim 3 wherein said antenna and said coupler are electrically coupled with a RF transmission line disposed in a coupling section coupled to said first section and to said second section.

6. The support structure of claim 1 wherein the support structure further comprises at least one fixture for attaching the support structure to a dashboard.

7. The support structure of claim 6, wherein said at least one fixture is a suction cup.

8. The support structure of claim 6, wherein said at least one fixture is a velcro strap.

9. The support structure of claim 6, wherein said at least one fixture is an adhesive tab.

10. The support structure of claim 1, wherein the antenna is a non-isotropic antenna directing radiation substantially away from electronics of said vehicle.

11. The support structure of claim 10, wherein said antenna comprises a PIFA type antenna or a patch type antenna.

12. The support structure of claim 5, wherein the first and second sections include hollow portions for receiving said RF transmission line for connecting the antenna with the connector.

13. The support structure of claim 5, wherein said RF transmission line comprises a cable.

14. The support structure of claim 5, wherein said coupling portion includes a microphone which is electrically coupled with the coupler.

15. The support structure of claim 14, wherein said coupling portion further includes a loudspeaker coupled with the coupler.

16. The support structure of claim 15, further comprising speakerphone circuitry coupled between the coupler and the microphone and loudspeaker.

17. The support structure of claim 5, wherein said first, coupling and second sections are integrally formed.

18. The support structure of claim 17, wherein said second section comprises a first extension end and a movable extension section including the distal end, wherein the movable extension section mates with the first extension end.

19. A support structure for a mobile phone used in a vehicle, comprising:
a first section for receiving and supporting the mobile phone including a coupler for electrical connection with the mobile phone;
a second section comprising an antenna being electrically coupled via a RF transmission line with the coupler, said second section shaped to be placed on top of a dashboard of said vehicle close to a front windshield of said vehicle.

20. The support structure of claim 19, wherein the first section and the second section include a fixture for attachment to a dashboard, said fixture being a suction cup, a velcro strap, or an adhesive tab.

21. The support structure of claim 19, further comprising a coupling section coupled between said first and said second sections, said coupling section having a first end coupled to said first section and a second end coupled to said second section.

22. The support structure of claim 21, wherein said first section adjustably mates with said first end.

23. The support structure of claim 21, wherein said second section adjustably mates with said second end.

24. The support structure of claim 21, wherein said second section comprises a substantially horizontal section that can have its length altered adjustably and still maintain the electrical coupling of said RF transmission line between said coupler and said antenna.

25. The support structure of claim 19, wherein said antenna is a non-isotropic antenna.

26. The support structure of claim 25, wherein said antenna generates transmission beams directed substantially away from electronics in said vehicle.

27. The support structure of claim 25, wherein said antenna comprises a PIFA type antenna or a patch type antenna.

28. The support structure of claim 1, wherein said coupler comprises a connector.

29. The support structure of claim 1, wherein said coupler comprises an electromagnetic coupler.

30. The support structure of claim 1 wherein said coupler provides at least one electrical connection.

31. The support structure of claim 30, wherein said coupler includes a connector and an electromagnetic coupler.

32. The support structure of claim 19, wherein said coupler comprises a connector.

33. The support structure of claim 19, wherein said coupler comprises an electromagnetic coupler.

34. The support structure of claim 19 wherein said coupler provides at least one electrical connection.

35. The support structure of claim 19 wherein said coupler includes a connector and an electromagnetic coupler.
